(19) United States
(12) Patent Application Publication
(10) Pub. No.: US 2010/0073961 A1
(43) Pub. Date: Mar. 25, 2010

(54) LIGHT GUIDE WITH DUAL REFLECTING SURFACES TO MAXIMIZE LIGHT REFLECTION AND ENHANCE UNIFORMITY OF EMITTED LIGHT

(76) Inventors: Rong-Yaw WU, Hsin-Tien City (TW); Yen-Chin WANG, Hsin-Tien City (TW); Yen-Chieh CHEN, Hsin-Tien City (TW)

Correspondence Address: SINORICA, LLC, 2275 Research Blvd., Suite 500, ROCKVILLE, MD, 20850, US

(21) Appl. No.: 12/233,588

(22) Filed: Sep. 19, 2008

(51) Int. Cl. F21V 7/04; F21V 7/00

(52) U.S. Cl. 362/620; 362/298

(57) ABSTRACT

A light guide for a linear light source comprising dual light reflecting surfaces, a v-shaped light reflecting surface for maximizing light output and an asymmetrical saw-toothed light reflecting surface for enhancing the uniformity of emitted light is disclosed. The v-shaped light reflecting surface comprises two light reflecting surfaces at 90°. The asymmetrical saw-toothed light reflecting surface comprises notches and ridges with increasing gradient from the light entry end of the light guide to the opposite end. The asymmetrical saw-tooth has a constant pitch and constant saw-tooth angle. The light guide further comprises an apex cut-off surface and a bottom cut-off surface at the light entry end of the light guide to prevent light loss at the light entry point further enhancing the light channeling performance.

### BACKGROUND OF THE INVENTION

1. Field of the Invention

The present invention relates to a light guide for a linear light source. More specifically, the present invention discloses a highly efficient light guide with a first reflecting surface to maximize light reflection and a second reflecting surface to enhance the uniformity of the emitted light.

2. Description of the Prior Art

Linear light sources emit light in a different direction from the direction the light originated from. For example, a light is produced by a light emitting diode at an angle of zero degrees. By affecting the direction of the light beam the linear light source can emit the light at various angles such as 90 degrees.

Refer to FIG. 1, which is a drawing illustrating a light source of the prior art. As shown in FIG. 1, the conventional light source comprises a light emitting diode 110 and a transparent light rod 120. Both ends of the transparent light rod 120 are flat surfaces. When power is applied to the light emitting diode 110 the light emitting diode 110 emits light. Some of the light enters the transparent light rod 120. However, since the end of the transparent light rod 120 is flat, much of the light is reflected back and is lost. This lowers the efficiency and intensity of the light source.

The light that enters the transparent light rod 120 exits the side surface of the transparent light rod 120. Unfortunately, some of the light exits the transparent light rod 120 in directions not intended. This results in an additional loss of light. To overcome this disadvantage a reflective housing must be used in order to try to reflect the escaping light back into the transparent light rod 120. This increases the cost of the light source.

Additionally, since only one light emitting diode 110 is utilized in the conventional light source the emitted light is brighter closer to the light emitting diode 110 and dimmer at the far end of the transparent light rod 120. As a result the conventional light source's emitted light is not uniform.

Therefore, there is need for an improved light guide for a linear light source that is highly efficient and provides an emitted light that is uniform in intensity.

### SUMMARY OF THE INVENTION

To achieve these and other advantages and in order to overcome the disadvantages of the conventional method in accordance with the purpose of the invention as embodied and broadly described herein, the present invention provides a highly efficient light guide for a linear light source that maximizes light reflection, prevents light loss at the entry point, and provides a uniform emitted light.

The light guide for a linear light source of the present invention is comprised of transparent or semi-transparent material. The light guide bar is solid, semi-hollow or hollow.

The light guide of the present invention comprises a light emitting surface, a v-shaped light reflecting surface, an asymmetrical saw-toothed light reflecting surface, a bottom surface, a top surface, a light entry end surface, a light entry opposite end surface, an apex cut-off surface, and a bottom cut-off surface.

The light emitting surface is a surface of the light guide where light exits the light guide.

The v-shaped light reflecting surface is disposed on a surface of the light guide opposite the light emitting surface. The v-shaped light reflecting surface comprises two light reflecting surfaces at 90° apart. The center of the v-shaped light reflecting surface where the two light reflecting surfaces meet is the apex of the v-shaped light reflecting surface. The v-shaped light reflecting surface maximizes light output.

The top surface is disposed between the light emitting surface and the v-shaped light reflecting surface. The bottom surface is disposed opposite the top surface next to the bottom of the v-shaped light reflecting surface.

The asymmetrical saw-toothed light reflecting surface is disposed between the bottom surface and the light emitting surface. The asymmetrical saw-toothed light reflecting surface comprises a plurality of notches and ridges with increasing gradient from the light entry end to the end surface opposite the light entry end. The asymmetrical saw-toothed light reflecting surface enhances the uniformity of the emitted light.

Light emitted by a light source enters the light guide through the light entry end surface. The light exits the light guide on the light emitting surface. The asymmetrical saw-toothed light reflecting surface makes the emitted light more uniform in intensity thereby enhancing the quality of the linear light source.

The asymmetrical saw-toothed light reflecting surface comprises a plurality of notches and ridges. The depth of the notches is deepest on the light guide furthest away from the LED light source. The farther away from the LED light source the depth of the notches of the asymmetrical saw-toothed light reflecting surface gradually increases. In this way the asymmetrical saw-toothed light reflecting surface affects the light more gently where the light intensity is strongest (closer to the LED light source).

The light guide further comprises an apex cut-off surface and a bottom cut-off surface at the light entry end of the light guide to prevent light loss at the light entry point further enhancing the light channeling performance.

Additionally, the light travels through the light guide at various angles and is reflected by the v-shaped light reflecting surface thereby maximizing light output.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a drawing illustrating a light source of the prior art;

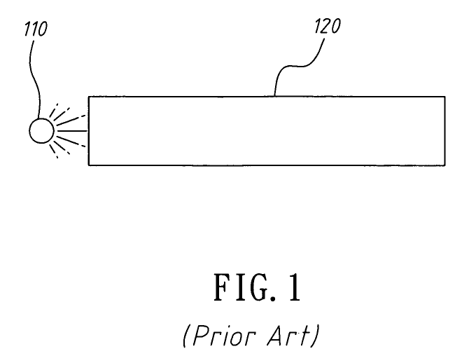

FIG. 2 is a three dimensional drawing illustrating a light guide with an asymmetrical saw-toothed light reflecting surface according to an embodiment of the present invention;

FIG. 3 is a cross-sectional view of a light guide with a curved light emitting surface according to an embodiment of the present invention;

FIG. 4 is a cross-sectional view of a light guide with a polygonal light emitting surface according to an embodiment of the present invention;

FIG. 5 is a drawing illustrating an asymmetrical saw-tooth pattern of the asymmetrical saw-toothed light reflecting surface according to an embodiment of the present invention;

FIG. 6A-6B are drawings illustrating an apex cut-off surface of the light guide according to an embodiment of the present invention; and

FIG. 7 is a drawing illustrating a bottom cut-off surface of the light guide according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

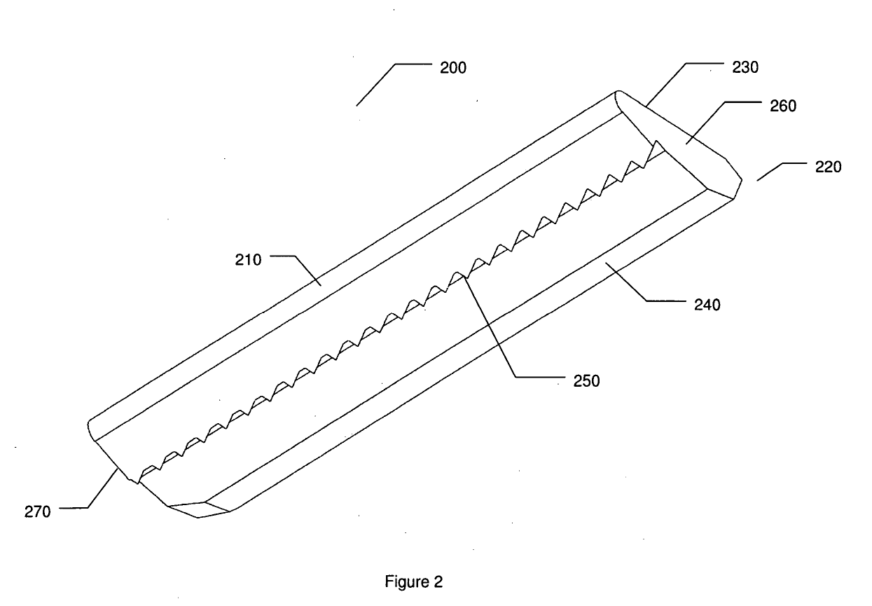

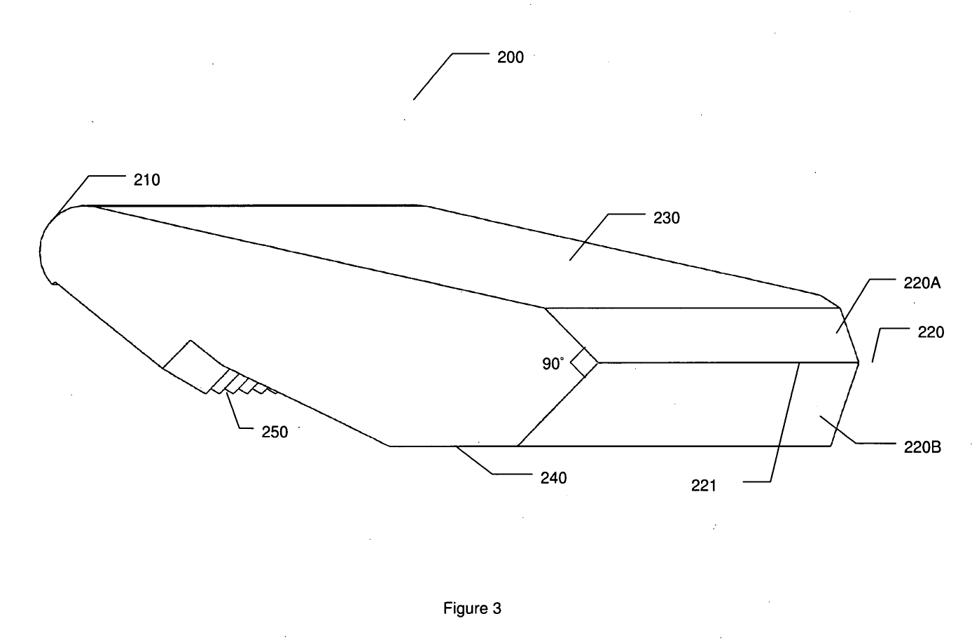

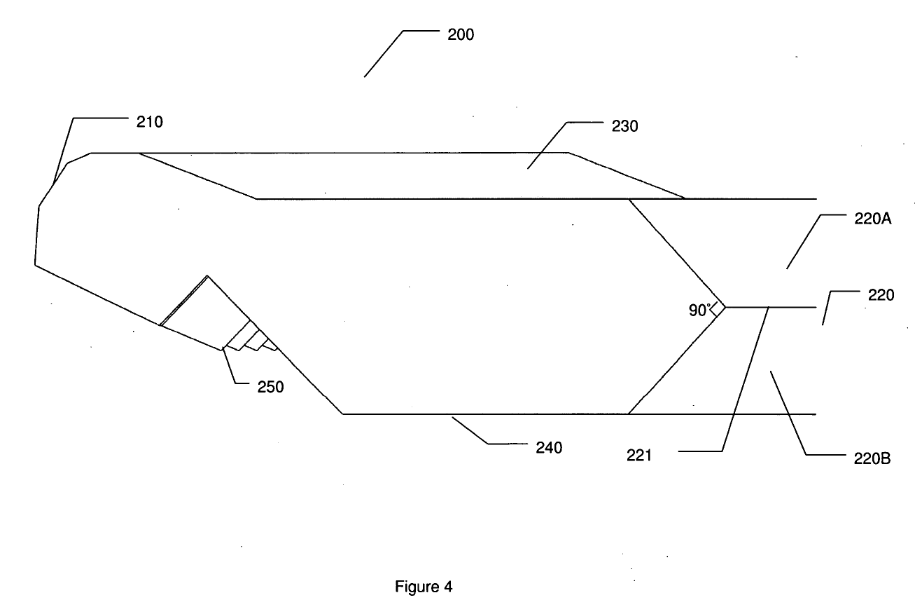

Refer to FIG. 2, which is a three dimensional drawing illustrating a light guide with an asymmetrical saw-toothed light reflecting surface according to an embodiment of the present invention, to FIG. 3, which is a cross-sectional view of a light guide with a curved light emitting surface according to an embodiment of the present invention, and to FIG. 4, which is a cross-sectional view of a light guide with a polygonal light emitting surface according to an embodiment of the present invention.

The light guide 200 of the present invention comprises a light emitting surface 210, a v-shaped light reflecting surface 220, an asymmetrical saw-toothed light reflecting surface 250, a bottom surface 240, a top surface 230, a light entry end surface 260, and a light entry opposite end surface 270.

The light emitting surface 210 is a surface of the light guide 200 where light exits the light guide 200. In the embodiment illustrated in FIG. 3 the light emitting surface is a curved or arc-shaped surface. In the embodiment illustrated in FIG. 4 the light emitting surface is a polygonal-shaped surface.

The v-shaped light reflecting surface 220 is disposed on a surface of the light guide 200 opposite the light emitting surface 210. The v-shaped light reflecting surface 220 comprises two light reflecting surfaces, a top light reflecting surface 220A and a bottom light reflecting surface 220B, at 90° apart. The center of the v-shaped light reflecting surface 220 where the two light reflecting surfaces meet is the apex 221 of the v-shaped light reflecting surface 220. The v-shaped light reflecting surface 220 maximizes light output.

The top surface 230 is disposed between the light emitting surface 210 and the v-shaped light reflecting surface 220. The bottom surface 240 is disposed opposite the top surface 230 next to the bottom light reflecting surface 220B of the v-shaped light reflecting surface 220.

The asymmetrical saw-toothed light reflecting surface 250 is disposed between the bottom surface 240 and the light emitting surface 210. The asymmetrical saw-toothed light reflecting surface 250 comprises a plurality of notches and ridges with increasing gradient from the light entry end surface 260 to the light entry opposite end 270 which is the end surface of the light guide 200 opposite the light entry end surface 260. The asymmetrical saw-toothed light reflecting surface 250 enhances the uniformity of the emitted light.

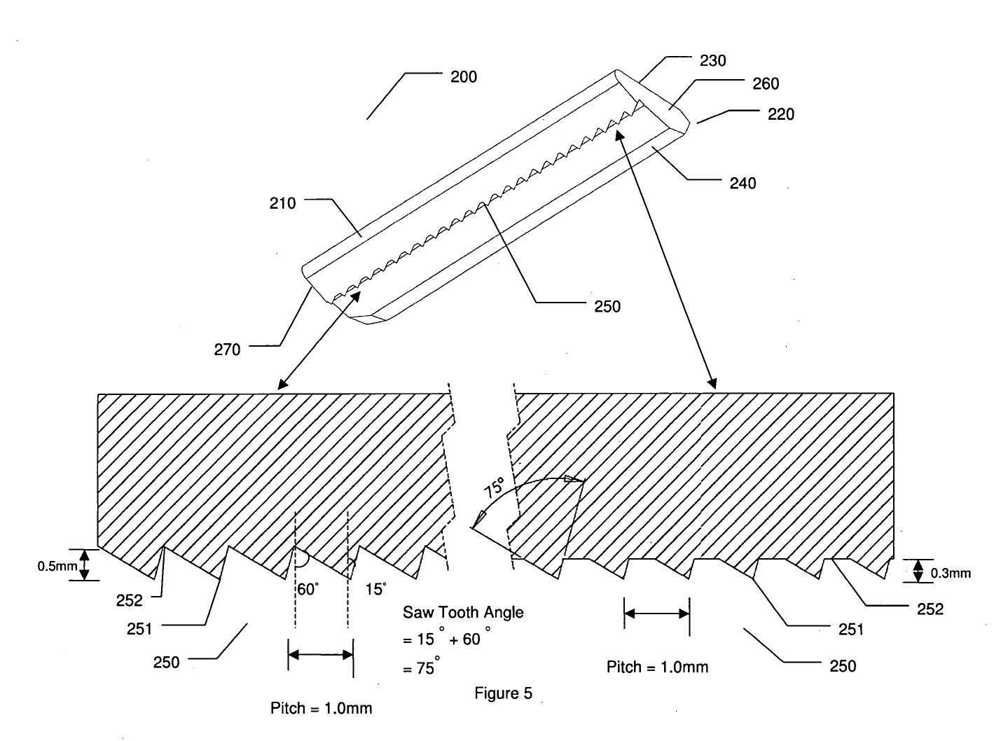

Refer to FIG. 5, which is a drawing illustrating an asymmetrical saw-tooth pattern of the asymmetrical saw-toothed light reflecting surface according to an embodiment of the present invention.

As shown in FIG. 5, the asymmetrical saw-toothed light reflecting surface 250 comprises an asymmetrical saw-tooth pattern of ridges 251 and notches 252. The asymmetrical saw-tooth pattern gradually increases in gradient from the light entry end surface 260 to the end opposite the light entry surface 270. The asymmetrical saw-tooth pattern has a constant saw-tooth angle and a constant pitch. In this embodiment of the present invention the constant saw-tooth angle is 75°. In other embodiments of the present invention the constant saw-tooth angle is greater or less than 75°. Also, in this embodiment the constant pitch is 1.0 mm. In other embodiments of the present invention the constant pitch is greater or less than 1.0 mm.

The saw-tooth height of the asymmetrical saw-tooth pattern gradually increases in height as the pattern moves away from the light entry end surface 260 and towards the opposite end 270 of the light guide 200. As shown in the lower left side of FIG. 5 at the end 270 of the light guide 200 the greatest distance from the light entry end surface 260 the ridges 251 and notches 252 are clearly defined to produce the asymmetrical pattern. At this end 270 the saw-tooth height or depth is greatest.

As shown in the lower right side of FIG. 5 at the end of the light guide 200 closest to the light entry end surface 260 the ridges 251 are clearly defined but the notches 252 are shallow valleys with flat surfaces. Again, as the pattern moves from the light entry end surface 260 towards the opposite end 270 of the light guide 200 the shallow valleys of the notches 252 gradually increase in depth until the notches 251 are clearly defined to produce a distinct saw-tooth.

In the embodiment illustrated in FIG. 5 the asymmetrical saw-tooth pattern begins with a saw-tooth height of 0.3 mm at the light entry end and rises to a saw-tooth height of 0.5 mm at the opposite end of the light guide. In other embodiments of the present invention other saw-tooth heights are utilized.

In another embodiment of the present invention, the asymmetrical saw-tooth pattern gradually decreases in height as the pattern moves away from the light entry end surface and towards the opposite end of the light guide.

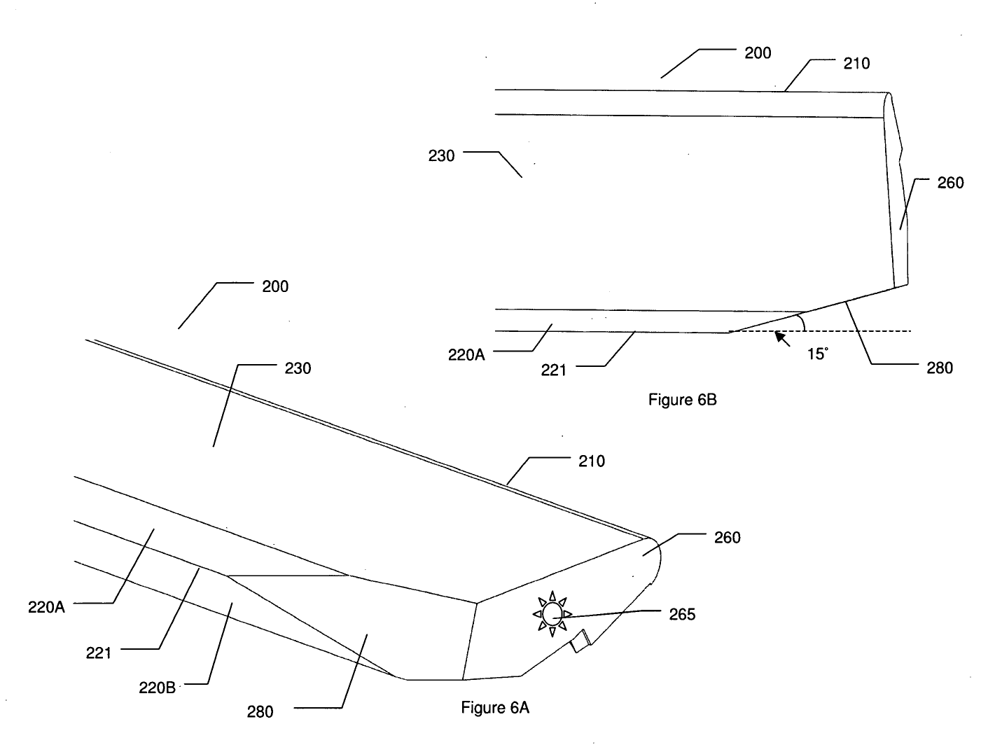

Refer to FIGS. 6A and 6B, which are drawings illustrating an apex cut-off surface of the light guide according to an embodiment of the present invention.

In the embodiment illustrated in FIGS. 6A and 6B the light guide 200 further comprises an apex cut-off surface 280. The apex cut-off surface 280 is at the light entry end surface 260 of the light guide 200. The apex cut-off surface 280 is at an angle from the apex 221 of the v-shaped light reflecting surface. The apex cut-off surface 280 prevents light loss at the light entry point further enhancing the light channeling performance on the light entry end. Light emitted by a light source 265 enters the light guide 200 via the light entry end surface 260. Light that might normally exit the light guide 200 near the light entry end surface 260 is reflected or channeled by the apex cut-off surface 280. In the embodiment illustrated in FIGS. 6A and 6B the angle from the apex 221 is 15°. In other embodiments of the present invention the angle is greater or less than 15°.

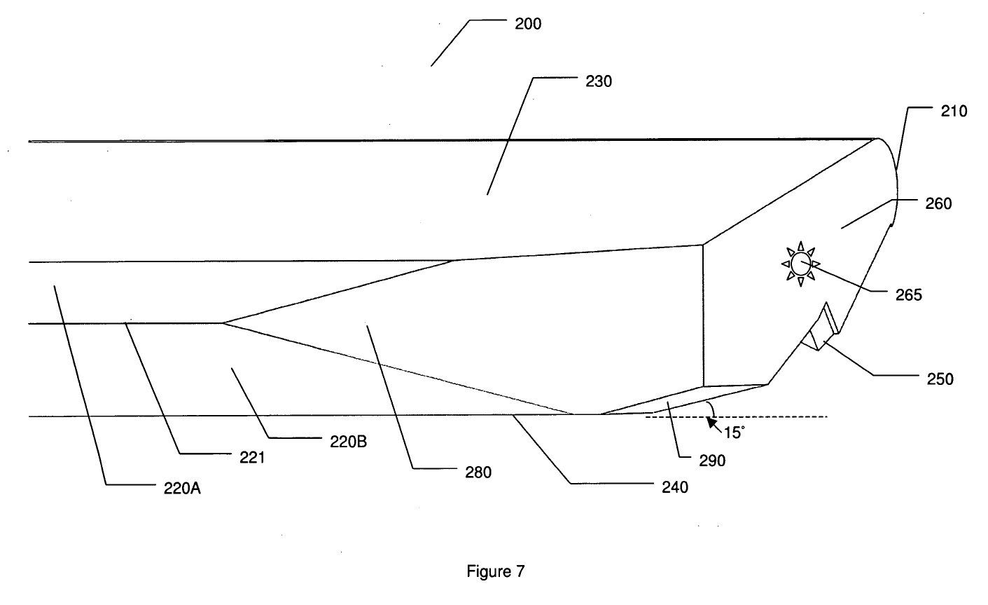

Refer to FIG. 7, which is a drawing illustrating a bottom cut-off surface of the light guide according to an embodiment of the present invention.

In the embodiment illustrated in FIG. 7 the light guide 200 further comprises a bottom cut-off surface 290. The bottom cut-off surface 290 is at the light entry end surface 260 of the light guide 200. The bottom cut-off surface 290 is at an angle from the bottom surface 240 of the light guide 200. The bottom cut-off surface 290 prevents light loss at the light entry point further enhancing the light channeling performance on the light entry end. Light emitted by a light source 265 enters the light guide 200 via the light entry end surface 260. Light that might normally exit the light guide 200 near the light entry end surface 260 is reflected or channeled by the bottom cut-off surface 290. In the embodiment illustrated in FIG. 7 the angle from the bottom surface 240 is 15°. In other embodiments of the present invention the angle is greater or less than 15°.

As described above the light guide of the present invention comprises dual light reflecting surfaces, a v-shaped light reflecting surface for maximizing light output and an asymmetrical saw-toothed light reflecting surface for enhancing the uniformity of emitted light. The v-shaped light reflecting surface comprises two light reflecting surfaces at 90°. The asymmetrical saw-toothed light reflecting surface comprises notches and ridges with increasing gradient from the light entry end of the light guide to the opposite end. The asymmetrical saw-tooth has a constant pitch and constant saw-tooth angle. The light guide further comprises an apex cut-off surface and a bottom cut-off surface at the light entry end of the light guide to prevent light loss at the light entry point further enhancing the light channeling performance.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A light guide for a linear light source comprising:
a light emitting surface;
a v-shaped light reflecting surface opposite the light emitting surface; and
an asymmetrical saw-toothed light reflecting surface disposed between the light emitting surface and the v-shaped light reflecting surface.

2. The light guide for a linear light source of claim 1, further comprising:
a top surface disposed between the light emitting surface and the v-shaped light reflecting surface; and
a bottom surface opposite the top surface between the asymmetrical saw-toothed light reflecting surface and the v-shaped light reflecting surface.

3. The light guide for a linear light source of claim 2, further comprising:
a light entry end surface disposed on a plane perpendicular to the top surface.

4. The light guide for a linear light source of claim 3, the asymmetrical saw-toothed light reflecting surface comprising:
a plurality of notches and ridges with increasing gradient from the light entry end surface to an end opposite the light entry end surface.

5. The light guide for a linear light source of claim 3, the asymmetrical saw-toothed light reflecting surface comprising:
a plurality of notches and ridges with decreasing gradient from the light entry end surface to an end opposite the light entry end surface.

6. The light guide for a linear light source of claim 1, the v-shaped light reflecting surface comprising two light reflecting surfaces at 90 degrees apart.

7. The light guide for a linear light source of claim 1, the light emitting surface comprising an arc-shaped surface.

8. The light guide for a linear light source of claim 1, the light emitting surface comprising a polygonal-shaped surface.

9. The light guide for a linear light source of claim 1, the asymmetrical saw-toothed light reflecting surface comprising a saw-tooth patterned surface with a constant pitch.

10. The light guide for a linear light source of claim 1, the asymmetrical saw-toothed light reflecting surface comprising a saw-tooth patterned surface with a constant saw-tooth angle.

11. The light guide for a linear light source of claim 1, the asymmetrical saw-toothed light reflecting surface comprising a saw-tooth patterned surface with an increasing saw-tooth depth.

12. The light guide for a linear light source of claim 1, the asymmetrical saw-toothed light reflecting surface comprising a saw-tooth patterned surface with an increasing saw-tooth height.

13. The light guide for a linear light source of claim 1, the asymmetrical saw-toothed light reflecting surface comprising a saw-tooth patterned surface with increasing gradient.

14. The light guide for a linear light source of claim 3, further comprising:
an apex cut-off surface on the light entry end surface of the light guide at a first angle from an apex of the v-shaped light reflecting surface.

15. The light guide for a linear light source of claim 14, where the first angle is 15 degrees.

16. The light guide for a linear light source of claim 3, the light guide further comprising:
a bottom cut-off surface on the light entry end surface of the light guide at a second angle from the bottom surface.

17. The light guide for a linear light source of claim 16, where the second angle is 15 degrees.

18. A light guide for a linear light source comprising:
a light emitting surface;
a v-shaped light reflecting surface opposite the light emitting surface;
a top surface disposed between the light emitting surface and the v-shaped light reflecting surface;
a bottom surface opposite the top surface; and
an asymmetrical saw-toothed light reflecting surface between the bottom surface and the light emitting surface.

19. The light guide for a linear light source of claim 18, further comprising:
a light entry end surface disposed on a plane perpendicular to the top surface.

20. The light guide for a linear light source of claim 19, the asymmetrical saw-toothed light reflecting surface comprising:
a plurality of notches and ridges with increasing gradient from the light entry end surface to an end opposite the light entry end surface.

21. The light guide for a linear light source of claim 19, the asymmetrical saw-toothed light reflecting surface comprising:
a plurality of notches and ridges with decreasing gradient from the light entry end surface to an end opposite the light entry end surface.

22. The light guide for a linear light source of claim 18, the v-shaped light reflecting surface comprising two light reflecting surfaces at 90 degrees apart.

23. The light guide for a linear light source of claim 18, the light emitting surface comprising an arc-shaped surface.

24. The light guide for a linear light source of claim 18, the light emitting surface comprising a polygonal-shaped surface.

25. The light guide for a linear light source of claim 18, the asymmetrical saw-toothed light reflecting surface comprising a saw-tooth patterned surface with a constant pitch.

26. The light guide for a linear light source of claim 18, the asymmetrical saw-toothed light reflecting surface comprising a saw-tooth patterned surface with a constant saw-tooth angle.

27. The light guide for a linear light source of claim 18, the asymmetrical saw-toothed light reflecting surface comprising a saw-tooth patterned surface with an increasing saw-tooth depth.

28. The light guide for a linear light source of claim 18, the asymmetrical saw-toothed light reflecting surface comprising a saw-tooth patterned surface with an increasing saw-tooth height.

29. The light guide for a linear light source of claim 18, the asymmetrical saw-toothed light reflecting surface comprising a saw-tooth patterned surface with increasing gradient.

30. The light guide for a linear light source of claim 19, further comprising:
an apex cut-off surface on the light entry end surface of the light guide at a first angle from an apex of the v-shaped light reflecting surface.

31. The light guide for a linear light source of claim 30, where the first angle is 15 degrees.

32. The light guide for a linear light source of claim 18, the light guide further comprising:
a bottom cut-off surface on the light entry end surface of the light guide at a second angle from the bottom surface.

33. The light guide for a linear light source of claim 32, where the second angle is 15 degrees.

34. A light guide for a linear light source comprising:
a light emitting surface;
a v-shaped light reflecting surface opposite the light emitting surface, the v-shaped light reflecting surface comprising two light reflecting surfaces at 90 degrees apart;
a top surface disposed between the light emitting surface and the v-shaped light reflecting surface;
a bottom surface opposite the top surface;
a light entry end surface disposed on a plane perpendicular to the top surface; and
an asymmetrical saw-toothed light reflecting surface between the bottom surface and the light emitting surface, the asymmetrical saw-toothed light reflecting surface comprising a plurality of notches and ridges with increasing gradient from the light entry end surface to an end opposite the light entry end surface.

35. The light guide for a linear light source of claim 34, the light emitting surface comprising an arc-shaped surface.

36. The light guide for a linear light source of claim 34, the light emitting surface comprising a polygonal-shaped surface.

37. The light guide for a linear light source of claim 34, the asymmetrical saw-toothed light reflecting surface comprising a saw-tooth patterned surface with a constant pitch.

38. The light guide for a linear light source of claim 34, the asymmetrical saw-toothed light reflecting surface comprising a saw-tooth patterned surface with a constant saw-tooth angle.

39. The light guide for a linear light source of claim 34, the asymmetrical saw-toothed light reflecting surface comprising a saw-tooth patterned surface with an increasing saw-tooth depth.

40. The light guide for a linear light source of claim 34, the asymmetrical saw-toothed light reflecting surface comprising a saw-tooth patterned surface with an increasing saw-tooth height.

41. The light guide for a linear light source of claim 34, further comprising:
an apex cut-off surface on the light entry end surface of the light guide at a first angle from an apex of the v-shaped light reflecting surface.

42. The light guide for a linear light source of claim 41, where the first angle is 15 degrees.

43. The light guide for a linear light source of claim 34, the light guide further comprising:
a bottom cut-off surface on the light entry end surface of the light guide at a second angle from the bottom surface.

44. The light guide for a linear light source of claim 43, where the second angle is 15 degrees.
